(19) United States
(12) Patent Application Publication
(10) Pub. No.: US 2018/0126709 A1
(43) Pub. Date: May 10, 2018

(54) MULTILAYERED AIR PERMEABLE LAMINATED HEAT INSULATION MATERIAL

(71) Applicants: Chang Yeon HWANG, Daejeon (KR); UPC LIMITED, Nonsan-si (KR)

(72) Inventor: Chang Yeon HWANG, Daejeon (KR)

(21) Appl. No.: 15/555,477

(22) PCT Filed: Mar. 3, 2016
(86) PCT No.: PCT/KR2016/002114

§ 371 Date: Dec. 29, 2017

(30) Foreign Application Priority Data
Mar. 5, 2015 (KR) 10-2015-0030860

(51) Int. Cl. B32B 27/12; B32B 27/32; B32B 27/20; B32B 15/20; B32B 15/085; B32B 7/12; E04B 1/78

(52) U.S. Cl. CPC B32B 27/12; B32B 27/32; B32B 27/20; A01G 9/24; B32B 15/085; B32B 7/12; E04B 1/78; B32B 15/20

(57) ABSTRACT

The present invention relates to a multilayered air permeable laminated heat insulation material and, more specifically, to a multilayered air permeable laminated heat insulation material having reinforced strength while maintaining air permeability, having excellent durability, waterproofness, heat insulation and moisture permeability for a building, and capable of preventing dew condensation.

### TECHNICAL FIELD

The present invention relates to a multilayered air permeable laminated heat insulation material. More specifically, the present invention relates to a multilayered air permeable laminated heat insulation material having reinforced strength while maintaining air permeability, having excellent durability, waterproofness, heat insulation and moisture permeability for a building, and capable of preventing dew condensation.

### BACKGROUND ART

In general, a vinyl house is formed by bending an iron pipe, etc., to create a tunnel-shaped frame and covering vinyl films such as a vinyl chloride film, a polyethylene film, etc., thereon. The vinyl house is used mainly for cultivation of vegetables, flowers and fruits, and in the livestock industry, and in particular, a vinyl house distributed for farms which is designed in consideration of weather disasters such as heavy snow, strong winds, and cold waves, etc., has types and standards, and thus, it is recommended to use appropriate sizes and materials for each use of the vinyl house.

In addition, since the vinyl house usually have a main purpose of keeping livestock, plants, etc., warm, in the winter when a temperature is low, heating is performed by increasing an internal temperature by operating a boiler or a hot air fan. To do this, it is normal to perform heating by burning buried resources such as solid fuels (coal, briquettes, etc.), liquid fuels (oil, etc.), gas fuels (gas etc.) to generate heat or by operating a heater or a hot air fan using electricity.

However, in this case, all the maintenance costs are high, and as a result, the costs for cultivated crops are increased, and thus, price competitiveness of products is lowered. In addition, in the case of the solid fuels and liquid fuels, there is a need for additional facilities for discharging gases that are harmful to the human body, which are generated while burning, to the outside. When the heating is performed using electricity, it is easy to manage, but there is a problem that the efficiency becomes low due to a large amount of electricity cost.

In particular, in the heating in the above-described manner, heat is generated locally only. Thus, a separate air conditioning facility is required to supply warmth to the entire vinyl house, and it is difficult to increase and maintain the temperature uniformly at one time.

Further, in the season when the heating is not needed, cold weather is prevented by simply covering the vinyl house with a non-woven fabric to achieve heat insulation. However, it is difficult to manage the non-woven fabric since it is necessary to repeat a cumbersome process of covering the vinyl house with the non-woven fabric at night and peeling back the non-woven fabric in consideration of a sunshine amount during the day rather than covering the vinyl house with the non-woven fabric continuously. Further, since the non-woven fabric is located outside the vinyl house, it is aged due to weather conditions (rain, snow, friction, external force, etc.) over time, and thus, there is a burden of replacement, and there is also difficulty in disposing waste occurring after the replacement.

As an improved method for heat insulating a vinyl house, Korean Patent Registration No. 10-0877790 (Jan. 2, 2009) discloses a technology of configuring a vinyl for a vinyl house including planar heating elements having a constant width along a length direction of a covered vinyl used for production of the vinyl house, constructing a vinyl house using the vinyl for a vinyl house, and applying power to the planar heating elements to maintain a temperature inside the vinyl house.

Further, Korean Utility Model Publication No. 1990-0002728 (Mar. 31, 1990) discloses, as a method for heat insulating a vinyl house, a protective cover for a vinyl house formed by laminating thin plate-like insulation materials made of styrofoam, urethane, or the like, between and on both side surfaces of the conventional bubble films, bonding a synthetic resin film onto both sides of the heat insulation material, and coating the surface with a synthetic resin film. However, the above method has a problem in that a lot of labor is required to remove the protective cover so as to receive the sunlight during the day and to cover it at night again.

As a technique for solving such a problem, Korean Patent Registration No. 10-0770694 (Oct. 22, 2007) discloses a heat insulation vinyl for a vinyl house capable of maximizing a heat insulation effect inside the vinyl house by continuously circulating hot air in a crossing direction between double vinyl layers installed in a vinyl house frame.

In the vinyl house in which heat insulation is performed only with one layer of vinyl which is generally used in small farmhouses, indoor heat is easily lost to the outside, resulting in considerable heat loss. A heat insulation material should be applied to prevent heat loss, but due to the cost of the heat insulation material to be added and large amounts of fuel and power used to increase the room temperature, the small farmhouses are largely burdened due to a complicated construction and facility investment costs. In addition, vinyl paper for vinyl house are overlapped in several layers to be used, but it is difficult to implement a rigid vinyl house structure and the effect of heat insulation is not great. Meanwhile, when the vinyl house is installed in a dual structure, heat insulation and durability may be increased, but it is required to install skeletons in a dual structure for adiabatic property and heat insulation, and to install vinyl in a dual manner.

To improve the above-described problems, Korean Patent Registration No. 10-0918608 (Sep. 16, 2009) discloses a technology of attaching a reinforcing member including an air pocket to a plurality of layers of vinyl sheets to prevent the vinyl in advance from being damaged by impacts such as hail, etc., wherein an air layer included in an air pocket is used to increase a heat insulation effect, and the vinyl structure of the vinyl house may be strong by further including a reinforcing mesh and a heating device.

As described above, even though many methods and materials have been disclosed for enhancing heat insulation and improving durability in vinyl houses widely used in an agricultural field, all of the above-described conventional methods still have problems in that separate power source or energy needs to be continuously operated to maintain a temperature inside the vinyl house, and the configuration is complicated, and thus, the installation and management are complicated and the cost is high.

Further, in the conventional heat insulation cover for a vinyl house, a dew condensation phenomenon occurs due to a high temperature inside and a low temperature outside, a lot of manpower is wasted to cover and remove due to a large thickness and a large volume, and edges in the removed state are formed with shadows due to volume, resulting in negatively influencing the crops.

In addition, the conventional heat insulation cover for a vinyl house still has problems in that it is difficult to sew due to a thick thickness, or a sewing thread is broken from a point where the sewing is not performed to thereby loose the entire thread, and then, the entire cover is not usable.

### PRIOR ART DOCUMENT

### Patent Literature

(Patent literature 1) Patent registered in Korea 10-0877790 (2009 Jan. 2)

(Patent literature 2) Patent registered in Korea 10-0770694 (2007 Oct. 22)

(Patent literature 3) Patent registered in Korea 10-0918608 (2009 Sep. 16)

(Patent literature 4) Korean Utility Model Publication 1990-0002728(1990 Mar. 31)

### DISCLOSURE

### Technical Problem

An object of the present invention is to provide a multilayered air permeable laminated heat insulation material capable of maintaining air permeability and having reinforced strength.

Another object of the present invention is to provide a multilayered air permeable laminated heat insulation material capable of preventing dew condensation and blocking radiant heat while simultaneously having excellent heat insulation, durability, tensile strength, and bonding force, and being easy to be constructed.

Still another object of the present invention is to provide a multilayered air permeable laminated heat insulation material capable of reducing a thickness and a volume of the air permeable laminated heat insulation material to facilitate workability, and being used by stacking two or more layers according to purposes and applications, thereby easily adjusting a temperature.

### Technical Solution

In one general aspect, a multilayered air permeable laminated heat insulation material includes: an air permeable laminated film formed on any one side or both sides of a heat insulation material, wherein the air permeable laminated film is formed by laminating an air permeable film and a non-woven fabric, the air permeable film including 20 to 60 parts by weight of an inorganic filler and 0.3 to 1.0 part by weight of an ultraviolet stabilizer based on 100 parts by weight of a polyolefin-based resin.

The multilayered air permeable laminated heat insulation material may be formed by bonding the heat insulation material and the air permeable film of the air permeable laminated film so that the non-woven fabric is exposed to the outside.

The multilayered air permeable laminated heat insulation material may further include: a non-woven fabric on any one side or both sides of the multilayered air permeable laminated heat insulation material.

A second non-woven fabric may be bonded to any one side of the heat insulation material, and the other surface of the heat insulation material to which the second non-woven fabric is not bonded may be bonded to the air permeable film of the air permeable laminated film so that the non-woven fabric of the air permeable laminated film is formed to be exposed to the outside.

The multilayered air permeable laminated heat insulation material in one layer or two or more layers may be used to be overlapped.

Binding portions may be formed by overlapping the heat insulation material and the air permeable laminated film, followed by sewing along a length direction at regular intervals in a width direction.

The air permeable film may further include a metal coating layer containing aluminum or silver particles on any one side, and the metal coating layer may be formed by gravure coating or depositing a solution containing aluminum or silver particles, or by heat-pressing or bonding an aluminum foil with an adhesive.

The heat insulation material may be any one or two or more selected from cotton, needle punching non-woven fabric, plastic foam, melt-blown non-woven fabric, exothermic cotton, fiber fabric, and woven fabric.

The air permeable laminated film may be obtained by bonding the air permeable film and the non-woven fabric using an adhesive composition, and the adhesive composition may include 50 to 90 wt % of a polyurethane adhesive resin in which polyether polyol and polyester polyol are mixed in a weight ratio of 50:50 to 20:80, 0.3 to 1 wt % of an ultraviolet (UV) stabilizer, 0.1 to 10 wt % of an accelerator, 1 to 20 wt % of a solvent, and 5 to 40 wt % of an isocyanate-based curing agent.

The non-woven fabric may include 0.3 to 1.0 part by weight of a HALS-based ultraviolet stabilizer based on 100 parts by weight of a polypropylene resin.

The multilayered air permeable laminated heat insulation material may satisfy Equations 1 to 4 below:

30≤L10≤120 [Equation 1]

20≤L20≤100 [Equation 2]

50≤L100≤150 [Equation 3]

50≤L30≤400 [Equation 4]

L10 in Equation 1 is a basis weight (g/m²) of the non-woven fabric, L20 in Equation 2 is a basis weight (g/m²) of the air permeable film, L100 in Equation 3 is a basis weight (g/m²) of the air permeable laminated film, and L30 in Equation 4 is a basis weight (g/m²) of the heat insulation material.

### Advantageous Effects

The multilayered air permeable laminated heat insulation material according to the present invention may have not only excellent air permeability but also excellent strength.

Further, it is possible to prepare the multilayered air permeable laminated heat insulation material having excellent waterproofness and heat insulation of a building while preventing dew condensation.

### DESCRIPTION OF DRAWINGS

FIG. 1 shows a multilayered air permeable laminated heat insulation material according to an exemplary embodiment of the present invention.

FIG. 2 shows a multilayered air permeable laminated heat insulation material in which air permeable laminated films are stacked on both sides of the heat insulation material according to an exemplary embodiment of the present invention.

FIG. 3 shows a multilayered air permeable laminated heat insulation material in which a non-woven fabric is stacked on one side of the heat insulating material according to an exemplary embodiment of the present invention, and an air permeable laminated film is stacked on the other side of the heat insulation material according to an exemplary embodiment of the present invention.

FIG. 4 shows a multilayered air permeable laminated heat insulation material further including a non-woven fabric according to another exemplary embodiment of the present invention.

FIG. 5 shows a multilayered air permeable laminated heat insulation material in which two layers of the multilayered air permeable laminated heat insulation materials according to another exemplary embodiment of the present invention are stacked.

### BEST MODE

Hereinafter, a multilayered air permeable laminated heat insulation material according to an exemplary embodiment of the present invention is described in detail. In addition, various advantages and features of the present invention and methods accomplishing thereof will become apparent with reference to Examples and Experimental Examples to be described in detail.

However, the present invention is not limited to the exemplary embodiments disclosed herein but will be implemented in various forms. The exemplary embodiments are provided by way of example only so that a person of ordinary skill in the art can fully understand the disclosures of the present invention and the scope of the present invention. Therefore, the present invention will be defined only by the scope of the appended claims.

Terms used in the present specification are for explaining Examples and Comparative Examples rather than limiting the present invention.

The present invention relates to a multilayered air permeable laminated heat insulation material including air permeable laminated film formed on both sides of the heat insulation material. The air permeable laminated film may be formed by laminating an air permeable film and a non-woven fabric. Further, the air permeable film may include 20 to 60 parts by weight of an inorganic filler and 0.3 to 1.0 part by weight of a ultraviolet (UV) stabilizer based on 100 parts by weight of a polyolefin-based resin.

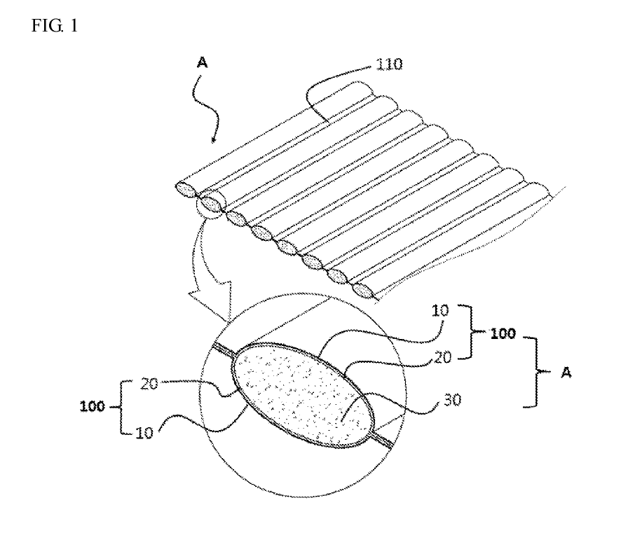

Further, FIGS. 1 to 4 are referred as preferred examples of the present invention.

First, FIG. 1 shows a multilayered air permeable laminated heat insulation material of the present invention.

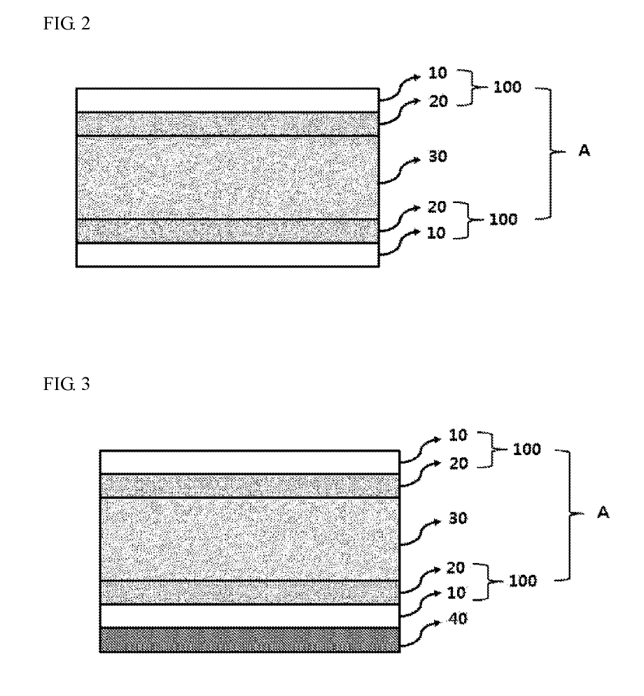

FIG. 2 shows a multilayered air permeable laminated heat insulation material including air permeable laminated films stacked on both sides of the heat insulation material according to an exemplary embodiment of the present invention.

FIG. 3 shows a multilayered air permeable laminated heat insulation material in which a non-woven fabric is stacked on one side of the heat insulating material according to an exemplary embodiment of the present invention, and an air permeable laminated film is stacked on the other side of the heat insulation material according to an exemplary embodiment of the present invention.

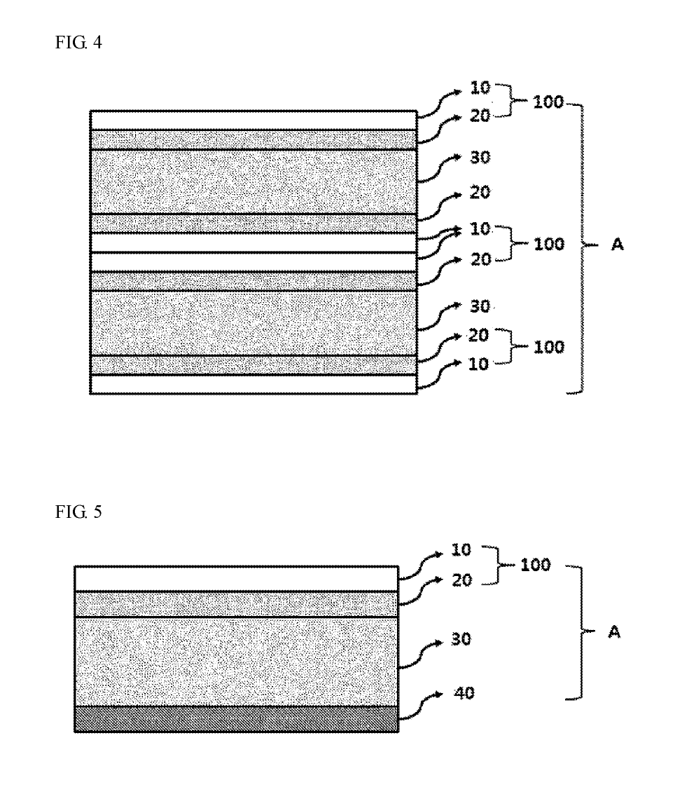

FIG. 4 shows a multilayered air permeable laminated heat insulation material further including a non-woven fabric according to another exemplary embodiment of the present invention.

FIG. 5 shows a multilayered air permeable laminated heat insulation material in which two layers of the multilayered air permeable laminated heat insulation materials according to another exemplary embodiment of the present invention are stacked.

Hereinafter, a multilayered air permeable laminated heat insulation material according to the present invention is described in detail.

The multilayered air permeable laminated heat insulation material (A) according to an exemplary embodiment of the present invention is characterized by stacking air permeable laminated films 100 on any one side or both sides of a heat insulation material 30, wherein the air permeable laminated film is formed by laminating a non-woven fabric 10 and an air permeable film 20.

The air permeable laminated film 100 according to an exemplary embodiment of the present invention is formed by laminating the non-woven fabric 10 and the air permeable film 20 to improve not only mechanical tensile strength but also water resistance and air permeability, thereby performing an important function in reducing a weight of the multilayered air permeable laminated heat insulation material of the present invention.

The non-woven fabric 10 serves to strengthen tensile strength, which is a mechanical property, and to prevent tearing, or the like from occurring, but is not limited thereto. Specifically, for example, any one selected from a non-woven fabric, a mesh film, or a fiber fabric prepared from spunbond, spunlace, needle punch, or the like, may be used. Preferably, polyester-based filament fibers or polyolefin-based filament fibers are preferably used to spin, and more preferably, a polypropylene resin is preferably used to spin. When the above-described resin is used, it is possible to achieve excellent air permeability, to obtain a desired strength, to prevent tearing, and simultaneously, to improve a heat insulation power. Further, the non-woven fabric 10 of the present invention may be prepared by being stacked into a multilayered web on a continuously moving belt, followed by heat-pressing or needle punching.

Further, the non-woven fabric 10 of the present invention may further include an ultraviolet (UV) stabilizer for improving durability. More preferably, the multilayered air permeable laminated heat insulation material is formed by including a HALS-based ultraviolet stabilizer, which is effective since the heat insulation material is not easily aged in ultraviolet rays even though it is exposed to the outside for a long time.

A content of the ultraviolet stabilizer is not limited, but may be 0.3 to 1.0 part by weight of the HALS ultraviolet stabilizer based on 100 parts by weight of the polypropylene resin.

Further, the non-woven fabric 10 of the present invention may further include a pigment depending on application and purpose. When titanium dioxide is contained, white color may be implemented, and when carbon, black organic pigment or black inorganic pigment is contained, a non-woven fabric having a black color may be prepared.

A content of the pigment is not limited, but it is effective for obtaining a clear color to contain 0.2 to 5.0 parts by weight of the pigment based on 100 parts by weight of the polypropylene resin.

The non-woven fabric according to an exemplary embodiment of the present invention may satisfy Equation 1 below:

30≤L10≤120 [Equation 1]

in Equation 1, L10 is a basis weight (g/m²) of the non-woven fabric.

When the basis weight of the non-woven fabric satisfies the above range, it is effective since it is possible to improve tensile strength, to prevent tearing from occurring, and to improve heat insulation.

In addition, according to another exemplary embodiment of the present invention, a second non-woven fabric may be further formed on any one side or both sides of the multilayered air permeable laminated heat insulation material. The heat insulation may be further improved by forming the second non-woven fabric.

Further, according to another exemplary embodiment of the present invention, a second non-woven fabric may be bonded to any one side of the heat insulation material, and the other surface of the heat insulation material to which the second non-woven fabric is not bonded may be bonded to the air permeable film of the air permeable laminated film so that the non-woven fabric of the air permeable laminated film is formed to be exposed to the outside. In this case, it is effective since it is possible to increase a heat blocking effect from the outside and prevent deformation.

According to an exemplary embodiment of the present invention, the air permeable film constituting the air permeable laminated film 100 may be produced by adding an inorganic filler and an ultraviolet stabilizer to the polyolefin resin to produce an extruded sheet, followed by stretching, and thus, waterproofness and air permeability may be improved.

The polyolefin resin is not limited, but specifically, for example, may be any one or a mixture of two or more selected from an ethylene-a-olefin copolymer resin, a low density polyethylene resin, and an ethylene-vinyl acetate copolymer resin. When the ethylene-α-olefin copolymer resin is used, for film flexibility, the ethylene-a-olefin copolymer resin having a density of 0.895 to 0.940 g/cm³ may be used, and the ethylene-a-olefin copolymer resin having a melt flow index of 0.8 to 5.0 g/10 min (190° C., 2.16 kg) may be used. In addition, any one selected from the group of consisting of butene, hexene and octene may be used as a-olefin of the ethylene-α-olefin copolymer resin. When the low density polyethylene resin is used, the low density polyethylene resin having a density of 0.9 to 0.95 g/cm³ and a melt index of 2.5 to 7 g/10 min (190° C., 2.16 kg) may be used. Further, when the ethylene-vinyl acetate copolymer resin is used, it is preferable to use the resin having a vinyl acetate content of 5 wt % or more, preferably 5 to 30 wt %, a density of 0.910 to 0.940 g/cm³, and a melt index of 1 to 4 g/10 min (190° C., 2.16 kg).

When a mixture of two or more resins is used for the polyolefin resin, when an amount of the low-density polyethylene is large, film processibility may be increased. In addition, when the content of the ethylene-vinyl acetate copolymer resin is increased to a certain level, it is effective since dispersibility of the inorganic filler may be improved.

The polyolefin resin according to an exemplary embodiment of the present invention is preferably selected from polypropylene, low density polyethylene, high density polyethylene, linear low density polyethylene or medium density polyethylene. The polyolefin resin is not limited as long as it has a molecular weight sufficient to form a film. For example, in the present invention, a polyolefin resin having a density of 0.910 to 0.940 g/cm³ is effectively used to maintain mechanical properties, air permeability, and moisture permeability.

The inorganic filler is not limited as long as it is an inorganic filler well known in the art. For example, any one or two or more selected from calcium carbonate, silica, clay talc, talc, barium sulfate, alumina, zeolite, etc., may be used. An average particle diameter of the inorganic filler may be selected according to the purpose of the invention. In order to improve the moisture permeability, air permeability and mechanical strength of the air permeable laminated heat insulation material of the present invention, it is preferable to use an inorganic filler having an average particle diameter of 0.5 to 30 μm, preferably 0.7 to 5.0 μm, but the inorganic filler is not limited thereto.

A content of the inorganic filler is adjusted as necessary. For example, the content thereof is 10 to 200 parts by weight, preferably 10 to 150 parts by weight, and more preferably 20 to 40 parts by weight based on 100 parts by weight of the polyolefin-based resin. When the inorganic filler is included in the above-described range, it is effective since flexural strength, elasticity and flexibility may be remarkably improved.

Further, the air permeable film 20 of the present invention may further include an ultraviolet (UV) stabilizer for improving durability. The multilayered air permeable laminated heat insulation material is formed by including the ultraviolet stabilizer, which is effective since the heat insulation material is not easily aged in ultraviolet rays even though it is exposed to the outside for a long time.

A content of the ultraviolet stabilizer is not limited, but may be 0.3 to 1.0 part by weight of the ultraviolet stabilizer based on 100 parts by weight of the polyolefin resin.

According to an exemplary embodiment of the present invention, a metal coating layer may be formed on any one side of the air permeable film. The metal coating layer may be formed to enhance a heat insulation effect due to heat reflection and to block indoor heat from escaping to the outside or to reflect the heat.

A method of forming the metal coating layer is not limited as long as it is a method obvious to the technical field. For example, the metal coating layer may be formed by gravure coating or depositing a solution containing aluminum or silver particles, or by heat-pressing or bonding an aluminum foil with an adhesive. The adhesive is not limited, but may be a urethane adhesive, and may be the same as or different from an adhesive composition used in attaching the non-woven fabric and the air permeable film at the time of producing the air permeable laminated film.

In particular, when a solution containing aluminum particles, silver particles having an average particle diameter of 8 to 15 μm, or the like, is coated on the air permeable film by a gravure method, it is effective since it is possible to prepare an air permeable laminated heat insulation material capable of having excellent tensile strength, breaking strength, and air permeability while simultaneously increasing a heat insulation effect, and satisfying heat reflectivity.

The air permeable film according to an exemplary embodiment of the present invention may satisfy Equation 2 below:

20≤L20≤100 [Equation 2]

in Equation 2, L20 is a basis weight (g/m²) of the air permeable film.

When the basis weight of the air permeable film satisfies the above range, it is effective since tearing does not occur, and air permeability and moisture permeability may be improved.

According to an exemplary embodiment of the present invention, the air permeable laminated film 100 may be formed by bonding the non-woven fabric 10 and the air permeable film 20 using an adhesive composition.

The bonding may be performed by spray coating or gravure roll coating using the adhesive composition, but is not limited thereto. By performing the bonding by the spray coating or the gravure roll coating method, the adhesive composition may be uniformly applied to improve close adhesion force, and coating portions and non-coating portions may be formed to further improve the air permeability.

According to an exemplary embodiment of the present invention, the adhesive composition is not significantly limited, but it may be appreciated that when the polyurethane adhesive is used, heat insulation may be further increased. More specifically, the adhesive composition may include 50 to 90 wt % of the polyurethane adhesive resin in which polyether polyol and polyester polyol are mixed in a weight ratio of 50:50 to 20:80, 0.1 to 10 wt % of an accelerator, 1 to 20 wt % of a solvent, 0.3 to 1.0 wt % of an ultraviolet (UV) stabilizer, and 5 to 40 wt % of an isocyanate-based curing agent, and It may be confirmed that when the adhesive composition is used, the heat insulation may be further increased.

The air permeable laminated film according to an exemplary embodiment of the present invention may satisfy Equation 3 below:

50≤L100≤150 [Equation 3]

in Equation 3, L100 is a basis weight (g/m²) of the air permeable laminated film.

When the basis weight of the air permeable laminated film satisfies the above range, it is effective since tearing may not occur, and heat insulation, air permeability and moisture permeability may be improved.

According to an exemplary embodiment of the present invention, the heat insulation material may be formed to improve adiabatic property and heat insulation. The heat insulation material may be specifically any one or two or more selected from the group consisting of polyethylene cotton, polypropylene cotton, polyester cotton, needle punching non-woven fabric, plastic foam, melt-blown non-woven fabric, polyolefin-based non-woven fabric, polyolefin resin, exothermic cotton, fiber fabric, woven fabric, etc., is not necessarily limited thereto.

The heat insulation material according to an exemplary embodiment of the present invention may satisfy Equation 4 below:

50≤L30≤400 [Equation 4]

in Equation 4, L30 is a basis weight (g/m²) of the heat insulation material.

When the basis weight of the heat insulation material satisfies the above range, it is effective since the adiabatic property and heat insulation may be remarkably improved.

According to an exemplary embodiment of the present invention, in the multilayered air permeable laminated heat insulation material 100, binding portions 110 may be formed by overlapping the heat insulation material 10 and the air permeable laminated film 20, followed by sewing along a length direction at regular intervals in a width direction.

Preferably, the heat insulation material 30 and the air permeable film 20 of the air permeable laminated film 100 may be bonded so that the non-woven fabric 10 is exposed to the outside so that the heat insulation is improved, and two or more layers are easily stacked to be used according to application.

Further, in order to further improve the heat insulation, it is possible to provide a multilayered air permeable laminated heat insulation material in which the binding portions are formed by sequentially overlapping the heat insulation material and the non-woven fabric on the other side of the second non-woven fabric, followed by sewing along a length direction at regular intervals in a width direction.

According to an exemplary embodiment of the present invention, in the multilayered air permeable laminated heat insulation material, the binding portions may be formed by sewing along the length direction at regular intervals of 10 to 30 cm in the width direction, thereby preventing heat loss and dew condensation phenomenon, increasing structural strength and shortening time for installation and maintenance.

The multilayered air permeable laminated heat insulation material according to an exemplary embodiment of the present invention may be easily installed and removed, and thus, one or two or three or more layers thereof may be used to be overlapped in order to adjust a temperature to be a desired temperature of a building or a crop.

Conventionally, the air permeable heat insulation material is prepared as thick as possible for improving the heat insulation, and thus, there are disadvantages in that it is difficult to install and collect the heat insulation material, and it is difficult to adjust the temperature precisely. In order to overcome the disadvantages of the conventional air permeable heat insulation material, the multilayered air permeable laminated heat insulation material of the present invention has a small volume, a small thickness, and a light weight to be advantageous in workability, and is excellent in durability, waterproofness and heat insulation while being capable of sewing since a total thickness is not thick.

Hereinafter, although Examples of the present invention have been disclosed for illustrative purposes in detail, the present invention is not limited to the following Examples.

Hereinafter, physical properties were measured by the following methods.

1) Heat Insulation Test (Unit: %)

The heat insulation was measured according to the KS K 0560 constant temperature method.

2) Tensile Strength

The tensile strength was measured according to the KS K ISO 9073-3 standard.

3) Measurement of Actual Heat Insulation Property

The multilayered air permeable laminated heat insulation material of the present invention was installed on the ground in a melon verification packing house of Seongju Agricultural Technology Center, Seongju-gun, Gyeongsangbuk-do, Republic of Korea. Then, ground temperatures and atmospheric temperatures in the heat insulation cover were measured at 7:00 am for 20 days from January 30th to Feb. 18, 2014, and each average of the temperatures were calculated.

### EXAMPLE 1

Filament fibers in which 0.6 part by weight of an ultraviolet stabilizer (Chimassorb 944, HALS-based, BASF) is mixed based on 100 parts by weight of polypropylene (H7700, LG Chem.) were subjected to spinning and stacked into a multilayered web on a continuously moving belt so that a basis weight was 60 g/m², followed by heat-bonding to prepare a non-woven fabric.

55 parts by weight of calcium carbonate (Yabashi Korea, YK1C) and 0.6 parts by weight of an ultraviolet stabilizer (Chimassorb 944, HALS-based, BASF) were mixed based on 100 parts by weight of low density polyethylene (Hanwha Chemical, HANWHA LDPE 955, density of 0.913 g/cm³) and melted. The molten material was subjected to T-die extrusion in a film extruder, and then uniaxially stretched by 2.5 times at a stretching temperature of 70° C. to form an air permeable film having a basis weight of 30 g/m².

A silver particle solution (product name: silver, manufactured by IDI) was coated on any one surface of the air permeable film by a gravure roll coating method to thereby form an air permeable film having a metal coating layer formed thereon.

An opposite side in which the metal coating layer of the formed air permeable film was stacked and laminated by applying a polyurethane adhesive (SAMHO Chemical Co., Ltd., SPH-7835) to an upper part of the non-woven fabric using a gravure roll coating method, thereby forming an air permeable laminated film 1 (basis weight: 90 g/m²).

An air permeable laminated film 2 having a basis weight of 60 g/m² was produced in the same manner as the above-described method of producing the air permeable laminated film except that the metal coating layer was formed.

In the air permeable laminated film 1 having a basis weight of 90 g/m², polyethylene cotton as a heat insulation material was stacked on the air permeable film, that is, the side on which the metal coating layer is formed so that a basis weight was 85 g/m², and another air permeable laminated film 2 (basis weight of 60 g/m²) was stacked so that the opposite side of the non-woven fabric faced the polyethylene cotton, followed by sewing along the length direction at an interval of 20 cm in the width direction, thereby producing a multilayered air permeable laminated heat insulation material, wherein a total basis weight was 235 g/m².

### EXAMPLE 2

Filament fibers in which 0.6 part by weight of an ultraviolet stabilizer (Chimassorb 944, HALS-based, BASF) is mixed based on 100 parts by weight of polypropylene (H7700, LG Chem.) were subjected to spinning and stacked into a multilayered web on a continuously moving belt so that a basis weight was 60 g/m², followed by heat-bonding to prepare a non-woven fabric, and a second non-woven fabric having a basis weight of 30 g/m² was prepared in the same manner.

The non-woven fabric of the air permeable laminated film 1 (basis weight of 90 g/m²) according to Example 1 was stacked to be in contact with an upper part of the second non-woven fabric (basis weight of 30 g/m²), the polyethylene cotton as a heat insulation material was stacked on the side on which the metal coating layer of the air permeable laminated film was formed so that the basis weight was 85 g/m², and another air permeable laminated film 2 (basis weight of 60 g/m²) was stacked so that the side on which the metal coating layer of the air permeable film was formed faced the polyethylene cotton and the non-woven fabric side was exposed to the outside, followed by sewing along the length direction at an interval of 20 cm in the width direction, thereby producing a multilayered air permeable laminated heat insulation material, wherein a total basis weight was 265 g/m².

### COMPARATIVE EXAMPLE 1

Polypropylene filament fibers (H7700, LG Chem.) were subjected to spinning and stacked into a multilayered web on a continuously moving belt so that basis weights were 100 g/m² and 60 g/m², respectively, followed by heat-bonding, thereby preparing first and second non-woven fabrics.

The second non-woven fabric (basis weight of 60 g/m²) was stacked on the first non-woven fabric (basis weight of 100 g/m²), the polyethylene cotton as a heat insulation material was stacked on the second non-woven fabric so that a basis weight was 170 g/m², and the second non-woven fabric (basis weight of 60 g/m²) and the first non-woven fabric (basis weight of 100 g/m²) were sequentially stacked again, followed by sewing along the length direction at an interval of 20 cm in the width direction, thereby producing a multilayered heat insulation material, wherein a total basis weight was 490 g/m².

TABLE 1

| | | Tensile strength | | Heat | Temperature (° C.) | |
|---|---|---|---|---|---|---|
| | Total weight | (kgf/cm²) | | insulation | Atmospheric | Ground |
| | (g) | MD | CD | (%) | temperature | temperature |
| Example 1 | 235 | 55 | 30 | 78 | 11.31 | 17.61 |
| Example 2 | 265 | 60 | 35 | 80 | 10.81 | 17.53 |
| Comparative | 490 | 65 | 38 | 72 | 10.71 | 16.21 |
| Example 1 | | | | | | |

As shown in Table 1, the multilayered air permeable laminated heat insulation material according to the present invention had excellent heat insulation, improved tensile strength to weight, and a light weight, which was easily installed and removed. In addition, it could be appreciated that a difference between the atmospheric temperature and the ground temperature was higher than that of the multilayered heat insulation material, and thus, actual heat insulation property was excellent.

On the other hand, the heat insulation material according to Comparative Example 1 had a total weight and thickness larger than those of the Examples, and thus, the tensile strength was slightly increased but the heat insulation was decreased, and the ground temperature according to Comparative Example 1 was lower than those of Examples, and thus, the actual heat insulation effect was lowered. Further, the heat insulation material of Comparative Example 1 was about twice as heavy as the weight of the heat insulation material of the Examples, and thus, a problem that the heat insulation material is not easily installed and removed still remained.

Therefore, according to the present invention, it could be appreciated that the air permeable laminated films in which the air permeable film and the non-woven fabric are laminated could be stacked on any one side or both sides of the heat insulation material, and thus, workability was excellent, and durability, waterproofness and heat insulation were improved due to small volume and thickness and light weight.

As described above, although preferred embodiments of the present invention are described, the present invention should be construed as including all the changes, modification, and equivalent, such that it is obvious that the present invention may be equivalently utilized by appropriately modifying the above-described exemplary embodiments. Therefore, the above-description is not intended to limit the scope of the present invention defined by limitation of the following claims.

### DETAILED DESCRIPTION OF MAIN ELEMENTS

10: NON-WOVEN FABRIC

20: AIR PERMEABLE FILM

100: AIR PERMEABLE LAMINATED FILM

110: BINDING PORTION

30: HEAT INSULATION MATERIAL

40: SECOND NON-WOVEN FABRIC

A: MULTILAYERED AIR PERMEABLE LAMINATED HEAT INSULATION MATERIAL

1. A multilayered air permeable laminated heat insulation material comprising:
an air permeable laminated film formed on any one side or both sides of a heat insulation material,
wherein the air permeable laminated film is formed by laminating an air permeable film and a non-woven fabric, the air permeable film including 20 to 60 parts by weight of an inorganic filler and 0.3 to 1.0 part by weight of an ultraviolet stabilizer based on 100 parts by weight of a polyolefin-based resin.

2. The multilayered air permeable laminated heat insulation material of claim 1, wherein the multilayered air permeable laminated heat insulation material is formed by bonding the heat insulation material and the air permeable film of the air permeable laminated film so that the non-woven fabric is exposed to the outside.

3. The multilayered air permeable laminated heat insulation material of claim 1, further comprising:
a second non-woven fabric on any one side or both sides of the multilayered air permeable laminated heat insulation material.

4. The multilayered air permeable laminated heat insulation material of claim 1, wherein a second non-woven fabric is bonded to any one side of the heat insulation material, and
the other surface of the heat insulation material to which the second non-woven fabric is not bonded is bonded to the air permeable film of the air permeable laminated film so that the non-woven fabric of the air permeable laminated film is formed to be exposed to the outside.

5. The multilayered air permeable laminated heat insulation material of claim 1, wherein the multilayered air permeable laminated heat insulation material in one layer or two or more layers are used to be overlapped.

6. The multilayered air permeable laminated heat insulation material of claim 1, wherein binding portions are formed by overlapping the heat insulation material and the air permeable laminated film, followed by sewing along a length direction at regular intervals in a width direction.

7. The multilayered air permeable laminated heat insulation material of claim 1, wherein the air permeable film further includes a metal coating layer containing aluminum or silver particles on any one side, and
the metal coating layer is formed by gravure coating or depositing a solution containing aluminum or silver particles, or by heat-pressing or bonding an aluminum foil with an adhesive.

8. The multilayered air permeable laminated heat insulation material of claim 1, wherein the heat insulation material is any one or two or more selected from cotton, needle punching non-woven fabric, plastic foam, melt-blown non-woven fabric, exothermic cotton, fiber fabric, and woven fabric.

9. The multilayered air permeable laminated heat insulation material of claim 1, wherein the air permeable laminated film is obtained by bonding the air permeable film and the non-woven fabric using an adhesive composition, and
the adhesive composition includes 50 to 90 wt % of a polyurethane adhesive resin in which polyether polyol and polyester polyol are mixed in a weight ratio of 50:50 to 20:80, 0.1 to 10 wt % of an accelerator, 1 to 20 wt % of a solvent, 0.3 to 1 wt % of an ultraviolet (UV) stabilizer, and 5 to 40 wt % of an isocyanate-based curing agent.

10. The multilayered air permeable laminated heat insulation material of claim 1, wherein the non-woven fabric includes 0.3 to 1.0 part by weight of a HALS-based ultraviolet stabilizer based on 100 parts by weight of a polypropylene resin.

11. The multilayered air permeable laminated heat insulation material of claim 1, wherein the multilayered air permeable laminated heat insulation material satisfies Equations 1 to 4 below:
30≤L10≤120 [Equation 1]
20≤L20≤100 [Equation 2]
50≤L100≤150 [Equation 3]
50≤L30≤400 [Equation 4]
L10 in Equation 1 is a basis weight (g/m2) of the non-woven fabric, L20 in Equation 2 is a basis weight (g/m2) of the air permeable film, L100 in Equation 3 is a basis weight (g/m2) of the air permeable laminated film, and L30 in Equation 4 is a basis weight (g/m2) of the heat insulation material.
